(19) United States
(12) Patent Application Publication
(10) Pub. No.: US 2003/0165154 A1
(43) Pub. Date: Sep. 4, 2003

(54) Digital media networking and arbitration system and method

(76) Inventors: Steven R. Lindsey, Lehi, UT (US); Richard C. Lindsey, Payson, UT (US); Craig B. Devries, West Valley, UT (US)

Correspondence Address: Paul C. Oestreich, TRASKBRITT, PC, P.O. BOX 2550, Salt Lake City, UT, 84110, US

(21) Appl. No.: 10/090,179

(22) Filed: Mar. 4, 2002

(51) Int. Cl. H04L 12/40; H04L 12/413

(52) U.S. Cl. 370/438; 370/445

(57) ABSTRACT

The present invention is a media networking and arbitration system including media and control buses interconnecting media network stations and configured for being retrofitted or adapted into conventional wiring or other media transmission schemes such as those found in residential, industrial, commercial or governmental installations. Methods of communicating and arbitrating media signals are also disclosed.

### TECHNICAL FIELD

This invention relates generally to networks. More particularly, the invention relates to a digital media network for transmitting digital video and audio signals between media network stations.

### BACKGROUND OF THE INVENTION

There has long been a need to be able to communicate with persons remotely located within buildings. One conventional approach to such communication is known as an “intercom” system. Generally, an intercom system may be characterized by a distributed, hard-wired, communication system within a structure that allows persons to communicate from remotely located stations within the structure. A discussion of some exemplary intercom systems and their shortcomings follows.

U.S. Pat. No. 3,978,468 to Bond et al. discloses an intercom call signaling mechanism including a single master unit capable of transmitting a digital code to a plurality of remote units in addition to two-way audio communication. The remote units of Bond et al. are capable of two-way audio communication and include a receiver to decode the transmitted by the master unit. U.S. Pat. No. 5,598,456 to Feinberg discloses an integrated telephone, intercom, security, and control system for a multi-unit building. U.S. Pat. No. 4,554,411 to Armstrong discloses an intercom system with a master control and various remote units. Communication between the master control unit and remote units is over a six-wire cable. According to Armstrong, discrete analog voltages are transmitted along a control line in response to switch commands. However, Bond et al., Feinberg and Armstrong are all examples of distributed intercom systems that are limited by a central switching device.

U.S. Pat. No. 4,996,709 to Heep et al. discloses an intercom telephone system for use in combination with a multi-line telephone system. The Heep et al. system uses the same wire pair as that used for the telephone system. Voice signals are transmitted on one or more frequency modulated channels so as not to interfere with normal amplitude modulated transmission of the phone system. One limitation of the Heep et al. system is its reliance on an existing multi-line telephone system. Additionally, there does not appear to be any digital video capability with the Heep et al. system.

Another conventional approach to communicating with remotely located persons in a structure is to use wireless technology. U.S. Pat. No. 5,802467 to Salazar et al. and U.S. Pat. No. 6,058,104 to Snelling et al., both disclose wireless communication systems that may be used as intercoms. However, neither Salazar et al. nor Snelling et al. appears to have the capability or bandwidth necessary for transmitting digital video signals.

U.S. Pat. Nos. 5,483,528 and 6,069,878, both to Christensen, disclose time division multiplexing (TDM) digital intercom systems. Christensen discloses the use of a TDM bus and digital matrix switching for replacing a conventional crosspoint switch. However, Christensen still relies on a central distribution scheme with a digital matrix switch.

Thus, there exists a need in the art for a digital media network and arbitration system including a network media bus for communicating with identical stations. Additionally, there exists a need in the art for a digital media network that may be retrofitted into conventional analog wiring used for conventional intercom systems in residential houses or other structures.

### SUMMARY OF THE INVENTION

The present invention relates to a digital media network and arbitration system. The present invention also includes methods of arbitrating a media bus using a control bus to avoid media transmission collisions. The digital media network system of the present invention allows every audio and/or video device in a house or office to be a potential source of media distribution. The media network system potentially allows expensive audio/visual equipment to be used for more than their originally intended purpose. For example and not by way of limitation, music from a stereo audio system may be broadcast to other rooms in a house, by using the media network system of the present invention. An advantage of the media network system of the present invention is potentially limitless scalability. In contrast, many conventional systems have limited scalability. Furthermore, conventional analog systems tend to be severely limited to cabling distances of less than one hundred feet. The digital technology of the media network system provides added flexibility by allowing cable distances over thousands of feet.

A method of switching arbitration in a media network system is disclosed. The method may include providing a digital media network system having a plurality of media network stations in communication with each other over a media network bus, wherein the digital media network bus includes a digital media bus and a digital control bus. The method may further include one of the plurality of digital media network stations creating a control packet and sending the control packet on the control bus to all other digital media network stations. The method may further include all of the other digital media network stations parsing the control packet. According to the method, if the control packet includes a system-wide broadcast command and there is no transmission on the media bus, the system-wide broadcast command is executed. According to the method, if the control packet includes a media network station-specific command, and there is no transmission on the media bus, a handshake is executed and the media network station-specific command is executed or else the command times out.

### BRIEF DESCRIPTION OF THE DRAWINGS

The drawings illustrate various embodiments for carrying out the invention. Additionally, like reference numerals refer to like parts in different embodiments in the drawings.

FIG. 1 is a block diagram of a digital media network station in accordance with the present invention.

FIG. 2 is a block diagram of a digital media network system in accordance with the present invention.

FIG. 3 is a flow chart of a method of switching arbitration in a media network system of the present invention.

### DETAILED DESCRIPTION OF THE INVENTION

The present invention relates to a digital media network and arbitration system. The present invention also includes methods of arbitrating a media bus using a control bus to avoid media transmission collisions. The digital media network system of the present invention allows every audio and/or video device in a house or office to be a potential source of media distribution. The digital media network system potentially allows expensive audio/visual equipment to be used for more than their originally intended purpose. For example and not by way of limitation, music from a stereo audio system may be broadcast to other rooms in a house, by using the digital media network system of the present invention. The digital media network system of the present invention provides the advantage of potentially limitless scalability. In contrast, many conventional systems have limited scalability. Furthermore, conventional analog systems tend to be severely limited to cabling distances of less than one hundred feet. The digital technology of the digital media network system provides added flexibility by allowing cable distances over thousands of feet.

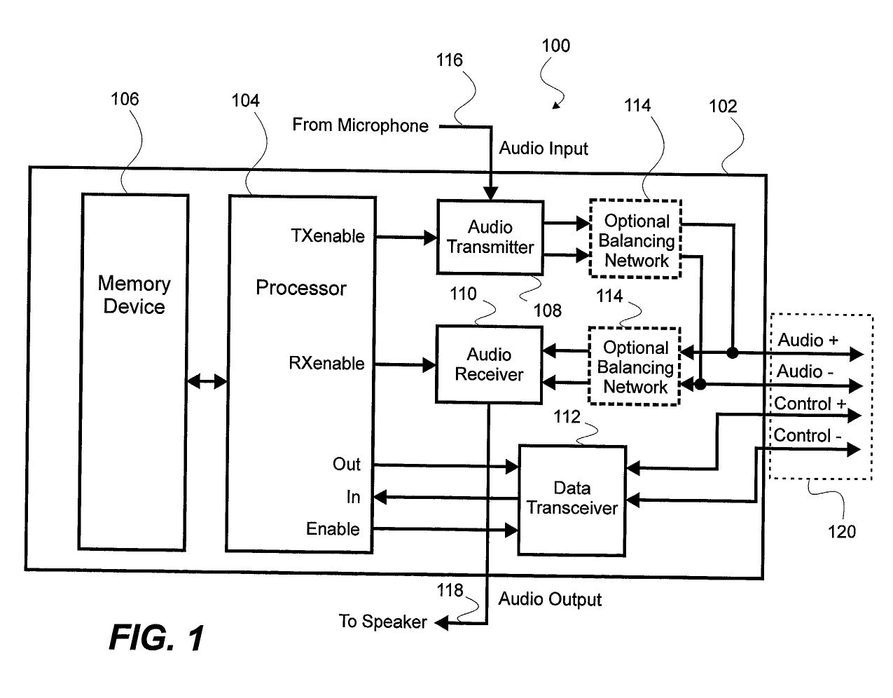

FIG. 1 is a block diagram of an embodiment of a digital media network station 100 in accordance with the present invention. Digital media network station 100 may include a substrate 102 for mounting a processor 104, a memory device 106, an audio transmitter 108, an audio receiver 110 and a data transceiver 112. Digital media network station 100 may optionally include balancing networks 114. Digital media network station 100 may also include an audio input 116 configured for connection to an audio input device (not shown). A suitable audio input device may be, for example, a microphone. Digital media network station 100 may also include a microphone (not shown) for converting sound waves from a user into electrical audio signals. Digital media network station 100 may also include an audio output 118 configured for connection to an audio output device (not shown). A suitable audio output device may be, for example, a speaker. Digital media network station 100 may also include a speaker for converting audio signals into sound wave audible to a user. While not shown for clarity, digital media network station 100 also includes, or is configured for connection to, a source of power. Digital media network station 100 may also be housed in packaging suitable for mounting on a wall and including a user interface for manual control and hands-free operation.

Processor 104 may be any suitable computer processor configured for executing computer instructions such as, for example, a microcontroller or a microprocessor. The selection of a suitable processor for use consistent with the present invention is within the skill of one of ordinary skill in the art. Additionally, processor 104 may be combined with memory device 106 using programmable devices such as a programmable gate array or other custom logic devices as known to one of ordinary skill in the art.

As shown in FIG. 1, processor 104 may be connected to audio transmitter 108 through signal transmit enable (hereinafter “TXenable”) and connected to audio receiver 110 through signal receive enable (hereinafter “RXenable”). Processor 104 may be connected to data transceiver 112 through signals Enable, Out and In. Digital media network station 100 is configured to communicate over a four-wire audio and control bus 120. Four-wire audio and control bus 120 includes two audio signals, Audio + and Audio −, which together may also be referred to herein as an “audio bus”. Four-wire audio and control bus 120 also includes two control signals, Control + and Control −, which together may also be referred to herein as a “control bus”. Four-wire audio and control bus 120 may be formed from, for example, an existing network of wires for a conventional intercom system that has been installed in a house. Audio transmitter 108 may be any suitable electronic device for receiving an audio signal from an audio device and transmitting the audio signal over an audio bus. Similarly, audio receiver 110 may be any suitable electronic device for receiving an audio signal from an audio bus and outputting the audio signal to a suitable audio output device. Audio transmitter 108 and audio receiver 110 may be combined into an audio transceiver (not shown) as known to one of ordinary skill in the art. Data transceiver 112 may be any suitable electronic device for transmitting and receiving control signals between processor 104 and a control bus.

Substrate 102 may be, for example, a printed circuit board or other suitable substrate for mounting electronic circuitry. Memory device 106 may be used to store computer instructions for implementing a method of switching arbitration for execution by processor 104 in accordance with another aspect of the present invention. Memory device 106 may be, for example, a read only memory (ROM), programmable ROM (PROM) electrically erasable PROM (EEPROM) or flash EEPROM. However, any suitable memory device 106 known to one of ordinary skill in the art may be conceivably used for storing computer instructions in accordance with the present invention.

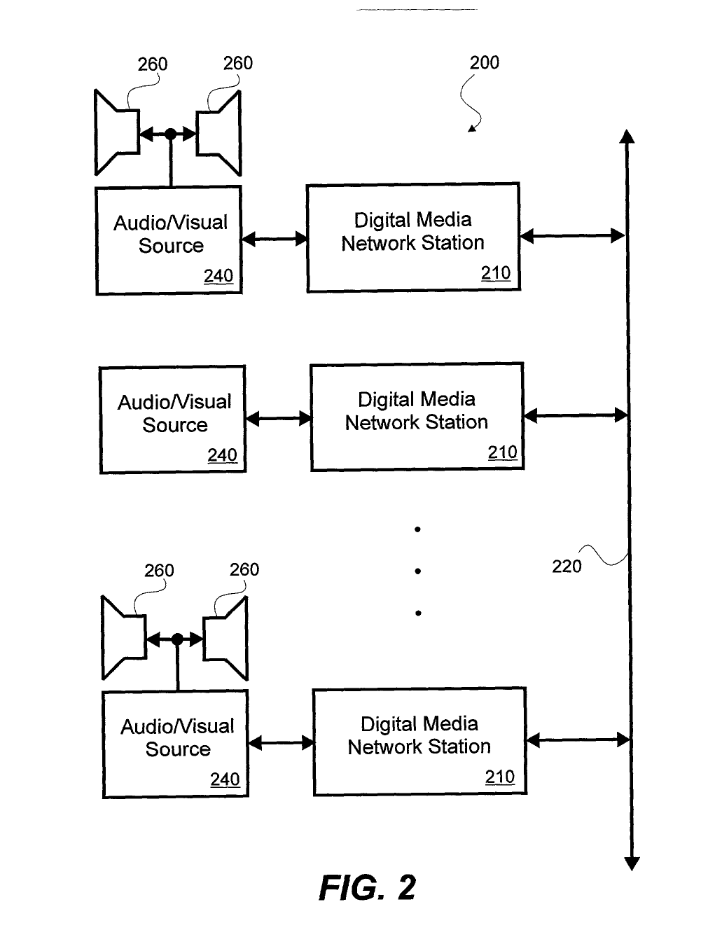

While the digital media network station 100 described above is particularly suited to distribution of compact disc quality audio over a digital media bus 120, the present invention is not limited to audio delivery alone. A more general embodiment of the present invention will be described with reference to the digital media network system 200 shown in FIG. 2. Additionally, one of ordinary skill in the art will recognize that there are many alternative circuits and levels of integration that may be used to perform the same function described for digital media station 100 above. For example, various levels of integration (ie., small scale integration (SSI), medium scale integration (MSI), large scale integration (LSI), very large scale integration (VLSI) and ultra-large scale integration (ULSI)) may be used to collapse or expand the functions described herein into fewer or more physical electronic devices as known to one of ordinary skill in the art. The particular number of physical electronic devices used to form digital media network station 100, for example, may be selected according to the particular needs of the particular application of the present invention.

FIG. 2 is a block diagram of a digital media network system 200 according to the present invention. Digital media network system 200 may include a plurality of digital media network stations 210 interconnected by a digital network bus 220. Digital network bus 220 may include at least one digital media bus (not shown for clarity) and a digital control bus (also not shown for clarity). Multiple digital media buses may be used in a digital network bus 220 consistent with the present invention. Digital media network system 200 may include practically any number of digital media network stations 210 networked together using the digital network bus 220. For a digital media network system 200 with a large number of digital media network stations 210, optional balancing networks may be used in conjunction with the digital media network bus 220 to compensate for transmission line effects. Each digital media network station 210 may be located in a different room of a house, on an external wall of a building, or even in buildings remote from each other. The digital media network bus 220 may be implemented using any suitable signal transmission technology such as, for example, electrical, infrared (IR), ultrasonic, radio frequency (RF) and fiber optic technologies.

Each digital media station 210 may be interfaced with an audio/visual source 240. Audio/visual source 240 may be any suitable mono or stereo audio component such as, for example, a compact disc (CD) player, a mini-disc (MD) player, a digital audio tape (DAT) player, an MP3 player, a cassette tape player, a digital compact cassette (DCC) player, or any other suitable audio source. Audio/visual source 240 may also be any suitable audio/visual source such as, for example, a television receiver, a cable television receiver, a satellite video receiver, a digital video camera or any other suitable audio/video source. Audio/visual source 240 may also be interfaced to one or more audio speakers 260. The audio that may be delivered over the digital media network 200 of the present invention may include any low, middle and high-end digital audio standards including Dolby™ Digital™, DTS™ and other home theater surround sound technologies.

Digital media network system 200 may be configured using any suitable combination or hardware and/or software, cabling and digital media network stations 100 to perform the following features: direct-dial to any room or selected multiple rooms where digital media network stations 100 are installed; hands-free operation, similar to a speakerphone, for both ends of a conversation once a connection has been established; music distribution (compact disc quality, digital stereo sound) to one room, selected multiple rooms, or all rooms where digital media network stations 100 are installed; privacy or “Do Not Disturb” mode, where other stations cannot communicate with a particular digital media network station 100; “Baby Monitor” mode, where one digital media network station 100 can listen to sounds, or monitor sounds, in another room with another digital media network station 100 installed; broadcast live voice to all rooms; and remote control of one digital media network station 100 from another room to set up music distribution or baby monitor modes.

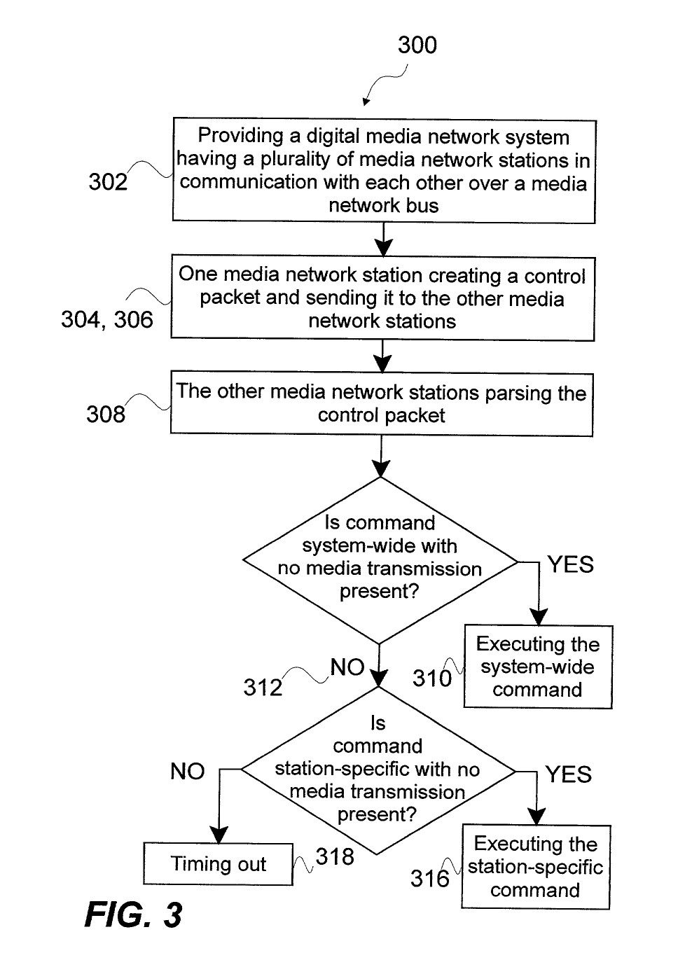

FIG. 3 illustrates a flow chart of a method 300 of switching arbitration in a media network system. Method 300 may include providing 302 a digital media network system having a plurality of media network stations in communication with each other over a media network bus, wherein the digital media network bus includes a digital media bus and a digital control bus. Method 300 may further include one of the plurality of digital media network stations creating 304 a control packet and sending 306 the control packet on the control bus to all other digital media network stations. Method 300 may further include all the other digital media network stations parsing 308 the control packet. According to method 300, if the control packet includes a system-wide broadcast command and there is no transmission on the media bus, the system-wide broadcast command is executed 310 or else continuing with other commands 312. According to method 300, if the control packet includes a media network station-specific command, and there is no transmission on the media bus, a handshake may be executed 314 and the media network station-specific command may be executed 316 or else the command times out 318.

A method for controlling multiple audio devices networked together on a common audio bus without contention may be accomplished by the use of a data control protocol that is transmitted on a digital control bus. Both analog and digital audio signals may be arbitrated using this method over any transmission medium available. Processor 104 (FIG. 1) may be configured to execute computer software instructions that monitor the control bus activity and provides the appropriate TXenable and RXenable signals (see FIG. 1) to the audio transmitter 108 and audio receiver 110, respectively, to prevent data collisions from occurring on the audio bus.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A media network station, comprising:
a media transceiver configured for sending and receiving media signals over a media bus;
a data transceiver for sending and receiving control signals over a control bus; and
a processor in communication with said media transceiver and said data transceiver for arbitrating transmission and reception of said media signals based on said control signals and preventing media signal collisions from occurring on said media bus.

2. The media network station according to claim 1, further comprising a switchable media bus termination network between said media transceiver and said media bus for balancing transmissions on said media bus.

3. The media network station according to claim 1, further comprising a switchable control bus termination network between said data transceiver and said control bus for balancing transmissions over said control bus.

4. The media network station according to claim 1, further comprising a media output connection in communication with said media transceiver for interconnecting received media signals with an external media device.

5. The media network station according to claim 1, further comprising a media input connection in communication with said media transceiver for interconnecting an external medial device with said media transceiver for media signal transmission over said media bus.

6. The media network station according to claim 1, further comprising a memory device in communication with said processor for storing computer instructions executable by said processor, said computer instructions implementing a method of switching arbitration to prevent said media signal collisions from occurring on said media bus.

7. A media network system, comprising:
a media bus;
a control bus; and
a plurality of media network stations connected to said media bus and said control bus, each digital media network station comprising:
a media transceiver configured for sending and receiving media signals over a media bus;
a data transceiver for sending and receiving control signals over a control bus; and
a processor in communication with said media transceiver and said data transceiver for arbitrating transmission and reception of said media signals based on said control signals and preventing media signal collisions from occurring on said media bus.

8. The media network system of claim 7, wherein each of said media network stations further comprises a memory device in communication with said processor for storing computer instructions executable by said processor, said computer instructions implementing a method of switching arbitration preventing said media signal collisions from occurring on said media bus.

9. The media network system of claim 7, wherein said media bus comprises a signal transmission technology selected from the group consisting of electrical, infra-red, ultrasonic, radio frequency and fiber optic technologies.

10. The media network system of claim 7, wherein said media bus comprises a plurality of media buses.

11. A method of switching arbitration in a media network system, said method comprising:
providing a digital media network system having a plurality of media network stations in communication with each other over a media network bus, said digital media network bus comprising:
a digital media bus; and
a digital control bus;
one of said plurality of digital media network stations creating a control packet;
said one digital media network station sending said control packet on said control bus to all other digital media network stations;
said all other digital media network stations parsing said control packet; and
if said control packet comprises a system-wide broadcast command and there is no transmission on said media bus, executing said system-wide broadcast command.

12. The method according to claim 11, further comprising, if said control packet comprises a media network station-specific command, and there is no transmission on said media bus, executing a handshake and said media network station-specific command or else timing out.

13. The method according to claim 12, wherein said executing a handshake further comprises validating a response to ensure correct processing of said media network station-specific command.

14. A method of switching arbitration in a media network system, said method comprising:
providing said media network system including at least three media network stations interconnected by a media bus and a control bus;
one of said at least three media network stations monitoring said control bus; and
said one of said at least three media network stations transmitting media signals to all other of said at least three media network stations if said media bus is not being used.
